(19) United States
(12) Patent Application Publication
(10) Pub. No.: US 2002/0176704 A1
(43) Pub. Date: Nov. 28, 2002

(54) Air freshener for motor vehicles

(76) Inventor: Andrew L. Roe, Memphis, TN (US)

Correspondence Address: H. Roy Berkenstock, Garvey, Smith, Nehrbass & Doody, L.L.C., Suite 3290, 3838 N. Causeway Blvd., Metairie, LA, 70002, US

(21) Appl. No.: 10/054,224

(22) Filed: Nov. 13, 2001

Related U.S. Application Data
(60) Provisional application No. 60/246,897, filed on Nov. 10, 2000.

(51) Int. Cl. H05B 3/00

(52) U.S. Cl. 392/393; 392/390; 392/403

(57) ABSTRACT

An air freshening device designed for use in motor vehicles. This device has a housing that is adapted for insertion into the motor vehicle cigarette lighter socket, implementing volt adapter technology for alternate uses of automobile cigarette lighter sockets (eg., adapters for . . . cellular phone, fax machines, televisions, DC Players, hair dryers, curling irons, even blenders). Within the housing there is alight. The light has a controllable variable resister which reflects the heat range and amount of light produced. The light has three functions: First to heat and activate the gel/cartridge, second, to produce a cosmetically pleasing color glow in the gel cartridge, third, the illuminated color glow fades as the fragrance is exhausted therefore acting as an indicator/gage to alert the user as to the amount of gel fragrance remaining. The gel/cartridge is removable from the housing. It is made of a type of plastic which is reactive to heat/warmth. The gel inside the plastic cartridge when heated produces a selected fragrance.

### CROSS-REFERENCE TO RELATED APPLICATIONS

This application claims priority of Provisional Application Ser. No. 60/246,897 filed Nov. 10, 2000.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

1. Field of the Invention

The present invention relates to an air freshening device designed for use in motor vehicles. This device is adapted for insertion into the motor vehicle cigarette lighter socket, implementing the now popular 12 volt adapter technology for alternate uses of automobile cigarette lighter sockets. Within the 12 volt adapter there is a light. The light has a variable resister which reflects the heat range and amount of light produced. The light has three functions. First, the light heats and activates the gel/cartridge. Second, it produces a cosmetically pleasing color glow in the gel cartridge. Third, the illuminated color glow fades as the fragrance is exhausted therefore acting as an indicator/gage to alert the user as to the amount of gel fragrance remaining. The air freshening gel/cartridge is removable from the 12 volt adapter. It is made of a type of plastic which is reactive to heat/warmth. The gel inside the plastic cartridge when heated produces a selected fragrance.

2. General Background of the Invention

The present invention air freshening device is based on the needs of both drivers and passengers to remove stale, bad odors from the cabin of the motor vehicle and add pleasant odors thereto. As used herein, the term “air freshening gel/cartridge” should be construed broadly to include vaporizable materials which take away odors and those which add pleasant odors. This air freshening gel/cartridge makes this device unique in that the gel inside the plastic cartridge shrinks as it alerts the user to the amount of gel left inside the cartridge as indicated by the variable resistor light/heat source.

Aroma generating automobile cigarette lighter devices and other devices using similar technologies are known. They are illustrated in U.S. Pat. Nos. 5,432,882, 2,898,649, 2,733,333, 4,346,059, 3,780,260, 6,021,254, and UK 2,062,199.

U.S. Pat. No. 5,432,882 utilizes a resistance wire heating element rather than a lamp and refers to no teaching of the use of a lamp to either heat the fragrance source or to illuminate the fragrance source for refill detection and compartment illumination.

U.S. Pat. No. 2,898,649 utilizes a lamp to evaporate the liquid perfume contained in a glass vial, the function of the lamp is primarily for the heating of a wick carrying the perfume and evaporation of the perfume. The lamp is said to illuminate the translucent handle through a translucent washer and in turn illuminate the perfume containing glass vial. In the Glo Plug device, the entire gel capsule containing the fragrance is heated, by projecting the illumination of the lamp directly through the capsule. Secondly, since the construction relies on a “solid-state” capsule as opposed to a liquid medium, it is possible to utilize selectively colored capsules in the Glo-Plug dispenser and to project that color into the passenger compartment with the direct lighting through the capsule provided with the device. It is not evident how the user of the U.S. Pat. No. 2,898,649 device observes the level of the perfume remaining in the vial other than perhaps by color since the handle is said to be translucent and not transparent. The cap appears to obstruct and direct projection of the light of the lamp into vial. Further, the U.S. Pat. No. 2,898,649 reference illustrates the usage of orifices as the vehicle to allow the fragrance to escape rather than the vapor permeable membrane utilized in Glo-Plug.

U.S. Pat. No. 2,733,333 utilizes a lamp as a source to vaporize an insecticide for household purposes. A lens projects some of the illumination of the lamp to confirm the “on” status of the dispenser. The only control is via an on/off switch.

U.S. Pat. No. 4,346,059 utilizes a rehostat to control the intensity of a light bulb in a novelty lamp to, in turn, control the heat output and the degree in which the fragrance is dispersed. The heat source (light bulb) warms a wicking surface upon which the liquid fragrance is sprayed.

U.S. Pat. No. 3,780,260 utilizes a light below a translucent fragrance containing container in a plug-in type night light to warm and evaporate the fragrance from the container. the fragrance serves as electrolyte to maintain the current to the bulb, and thus extinguish the light when the liquid falls below the electrode level.

U.S. Pat. No. 6,021,254 is directed to an auto air freshener including a timer for deactivating the release of fragrance after a predetermined period of time. The air freshener portion is similar to the household type which plug into a 110 volt socket.

British patent 2,062,199 is the only relevant international patent located. Two embodiments of fragrance dispensers are disclosed, one in which a standard vehicular cigarette lighter is adapted with a fragrance doped sobstrate such that when the lighter is pressed in for conventional heating and removed from the socket when heated so that the fragrance may be released into the vehicle interior. The second embodiment incorporates a receptacle mounted version wherein on seating the device to engage electrical contact, a lamp is illuminated to heat a doped and continuously release the fragrance.

None of the references show or allude to a variable resistance controllable lamp for selectively controlling both the amount of fragrance being evaporated by the dispenser or the amount of glow/illumination to the passenger compartment coupled with the monitoring of the remaining charge of fragrance, particularly incorporating the gel type fragrance charge, the evaporation of which provides a changing color and a relative indication of fragrance left.

### BRIEF SUMMARY OF THE INVENTION

An air freshening device designed for use in motor vehicles. This device is adapted for insertion into the motor vehicle cigarette lighter socket or power receptacle. This 12 volt adapter device includes a generally cylindrical housing, constructed of a type of plastic, which can be partially inserted into the power receptacle and cigarette lighter socket.

The end of the housing is adapted to hold a gel/fragrance cartridge. Inside the housing, there is a positive wire connected to a variable resister volume knob or like controller then to the positive post of the light/heat source. There is a negative post on light/heat source to the ground which completes the circuit. This variable resister light/heat source has three primary functions. The first is that it heats and activates the gel/cartridge. It also produces a cosmetically pleasing color glow in the gel cartridge. The illuminated color glow fades as the fragrance is exhausted, therefore acting as an indicator/gage to alert the user as to the amount of gel fragrance remaining. The light/heat source is an ordinary flash light type bulb. The variable resister is used to control the amount of light/heat that is projected through the gel/fragrance cartridge, thus controlling the amount of fragrance by moderating the vaporization of the air freshener, and the amount of light used to intensify the glow.

The inside of the housing has a shade lined with a foil type reflective material which intensifies the light and helps concentrate and direct the heat to the gel cartridge.

The gel/cartridge is removable from the 12 volt adapter. It is made of a type of plastic which is reactive to heat/warmth. The gel inside the plastic cartridge when heated produces a selected fragrance. When this cartridge is ready to be used, a foil plastic type seal is pealed away to expose a thinner type plastic, permeable material which allows the fragrance to escape. As the gel is heated/used it will begin to shrink alerting the user as to the amount of fragrance producing material left in the cartridge.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is an exploded perspective view of the preferred embodiment of the apparatus of the present invention;

FIG. 2 is a perspective view of the preferred embodiment of the apparatus of the present invention;

FIG. 3 is a cutaway perspective view of the preferred embodiment of the apparatus of the present invention;

FIG. 4 is an end view of the preferred embodiment of the apparatus of the present invention;

FIG. 5 is a fragmentary, perspective view of the preferred embodiment of the apparatus of the present invention illustrating the gel cartridge portion thereof;

FIG. 6 is a perspective view of an alternate embodiment of the apparatus of the present invention;

FIG. 7 is a perspective view of the alternate embodiment of the apparatus of the present invention and showing the housing in an alternate shape;

FIG. 8 is an end view taken along lines 8-8 of FIG. 7;

FIG. 9 is a fragmentary perspective view of the alternate embodiment of the apparatus of the present invention illustrating the cartridge in a liquid filled form;

FIG. 10 is a sectional view taken along lines 10-10 of FIG. 9;

FIGS. 11A-11C are schematic views that illustrate the liquid cartridge, showing the level of the liquid as the contents gradually evaporates during use.

### DETAILED DESCRIPTION OF THE INVENTION

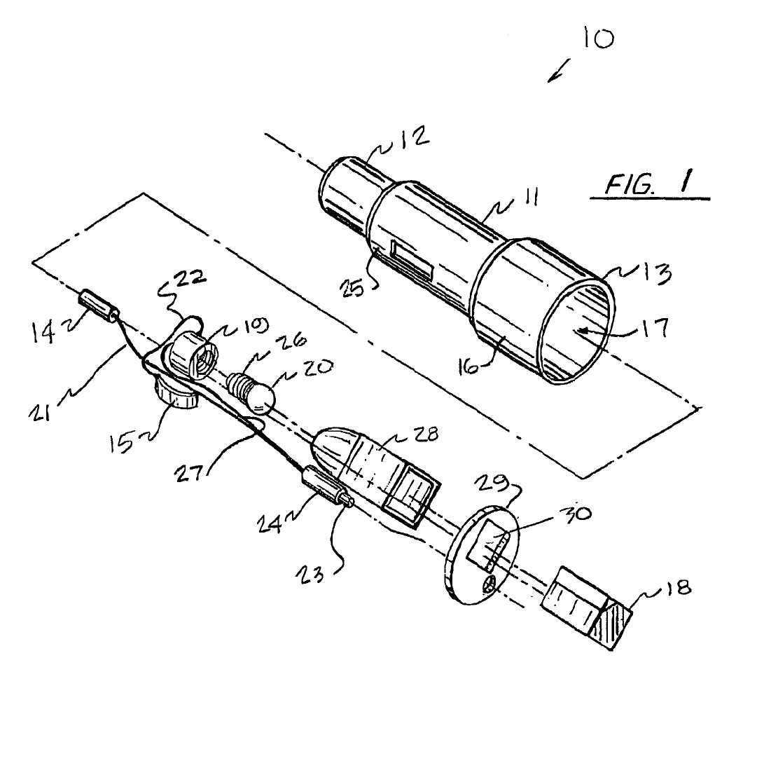

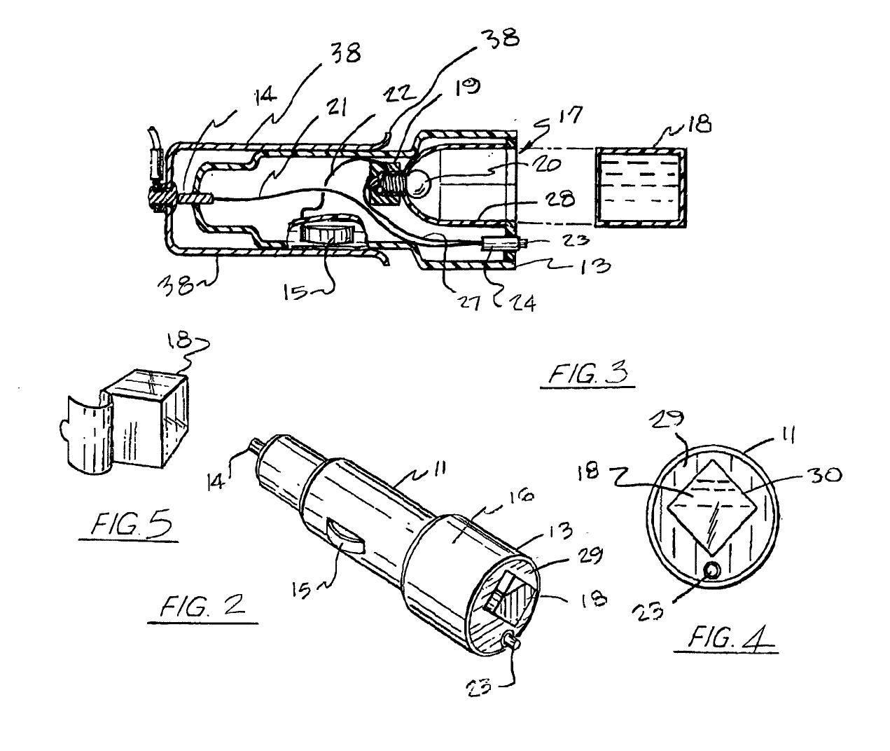

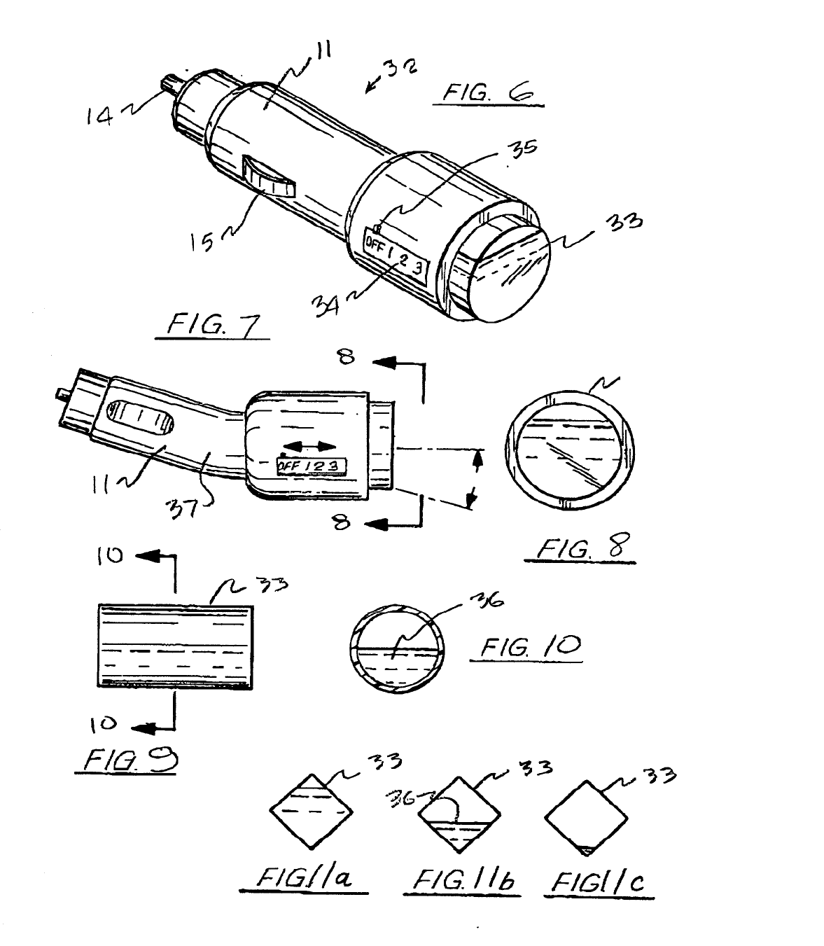

FIGS. 1-3 show the preferred embodiment of the apparatus of the present invention designated generally by the numeral 10. Motor vehicle air freshener 10 is comprised generally of a housing 11 having end portions 12, 13. End portion 12 has a positive contact 14. End portion 13 has an open socket 17. Socket 17 is sized and shaped to receive gel cartridge 18 which can be a cube or cylinder in shape, as shown in FIGS. 1-11. Housing 11 has a generally cylindrically shaped center section 25 that carries negative contact 15.

Center section 25 also has a fixture 19 positioned at one end of socket 17. The fixture 19 is a light fixture that can be internally threaded, for example, to form a connection with bulb 20 having an externally threaded stem 26.

Wire lead 21 is provided for forming a connection between the contact 14 and resistor 24 or other bulb intensity control. Wire lead 22 forms a connection between negative contact 15 and light fixture 19. Additionally, wire lead 27 forms a connection between resistor 24 and light fixture 19. Resister 24 can be provided with a variable resister knob 23 for varying the intensity of bulb 20 and thus the heat that it produces. The light bulb 20 thus has a variable resister 24 which reflects the heat range and amount of light produced.

The light bulb 20 and its resister 24 thus satisfy three functions: The bulb heats and activates the gel/cartridge 18. The light bulb produces a cosmetically pleasing color glow in the gel cartridge 18 which will be visible to a passenger in the motor vehicle when looking at the end portion 13 of housing 11 and more particularly at the socket 17 in which gel cartridge 18 is located. As a third function, the illuminated color glow fades as the fragrance is exhausted therefore acting as an indicator/gage to alert the user as to the amount of gel fragrance remaining.

The gel cartridge 18 is thus removable from the housing 11 at socket 17. The housing 11 is made of a type of plastic which is reactive to heat/warmth. The gel cartridge 18 is a plastic cartridge or like material that, when heated, produces a selected fragrance.

A shade 28 with a shiny lining can be provided for channeling light emitted by bulb 20 toward end 13 of housing 11. Plate 29 can be fitted to the circular socket 17 as shown in FIGS. 1, 2, 3 and 4. The plate 29 can be circular, providing a square opening 30 that receives the correspondingly shaped gel cartridge 18. Plate 29 has small opening 31 that receives variable resistor knob 23.

FIGS. 6-11C show an alternate embodiment of the apparatus of the present invention designated generally by the numeral 32. Motor vehicle air freshener 32 is similar to the preferred embodiment, but provides a cartridge 33 that is of a different construction. In the embodiment of FIGS. 6-11C, the cartridge 33 is a liquid filled cartridge that can be either cylindrically shaped (FIGS. 6-10) or cubed shaped (FIGS. 11A-11C). The housing 11 is similar to the construction of the preferred embodiment of FIGS. 1-5. Likewise, the electrical components are basically the same as those for the preferred embodiment of FIGS. 1-5. However, the resistor 24 is replaced with a sliding switch type resistor 34 having a switch member 35 that moves between positions “off”, “1”, “2”, and “3”. This type of resistor varies the intensity of bulb 20 by the use of a sliding action of switch member 35 from an off position to a lower intensity number 1 position, a medium intensity number 2 position or a maximum intensity number 3 position.

In the alternate embodiment, the cartridge 33 can be housed in a disposable plastic or glass cartridge 33 containing the liquid fragrance 36 that will slowly evaporate. As shown in FIGS. 11A-11C, the user will view the drop in level of the liquid 36, knowing when to dispose of the cartridge and replace it with another one.

In FIG. 7, the housing 11 is shown with a different shape, having a bend at 37. This bent orientation of the housing 11 is useful in adapting the apparatus 32 to some vehicles that have cigarette lighter outlets or like power outlets very low in the vehicle dash.

The apparatus 10 can be sized to fit into and obtain electrical power from an automobile or other vehicle cigarette lighter or like power port or receptacle, designated by the numeral 38.

The composition of the capsule will preferably include any suitable fragrant liquid or gel such as a commercially available fragrance oil, preferably between about 1% and 6% by weight. A dye soluble in the fragrance oil is provided for coloring the oil, the dye having a concentration of about 0.05% -0.2% by weight. If the capsule is to be a gel, a polymeric thickener such as Krayton (commercially available from Shell) can be added.

### Parts List

The following is a list of suitable parts and materials for the various elements of the preferred embodiment of the present invention.

| | |
|---|---|
| 10 | motor vehicle air freshener |
| 11 | housing |
| 12 | end portion |
| 13 | end portion |
| 14 | positive contact |
| 15 | negative contact |
| 16 | enlarged diameter section |
| 17 | socket |
| 18 | gel cartridge |
| 19 | fixture |
| 20 | bulb |
| 21 | wire lead |
| 22 | wire lead |
| 23 | variable resister knob |
| 24 | resister |
| 25 | center section |
| 26 | stem |
| 27 | wire lead |
| 28 | shade |
| 29 | plate |
| 30 | opening |
| 31 | opening |
| 32 | motor vehicle air freshener |
| 33 | cartridge |
| 34 | resistor |
| 35 | switch member |
| 36 | liquid |
| 37 | bend |
| 38 | receptacle |

The foregoing embodiments are presented by way of example only; the scope of the present invention is to be limited only by the following claims.

1. A motor vehicle air freshener apparatus comprising:
a) an elongated housing having first and second end portions and an inner compartment, the housing being configured to fit a tubular socket mounted on the dashboard of an automobile that is wired for electrical current;
b) a light bulb contained within the housing;
c) a pair of contacts for interfacing between the automobile tubular socket and electrical wiring of the housing;
d) a cartridge that fits the socket, the cartridge being of a material that when heated, produces a selected fragrance;
e) the light bulb functioning to heat the cartridge and housing and to transmit light into and through the gel cartridge to cause it to glow with a selected color.

2. The apparatus of claim 1 wherein the cartridge has a reservoir for containing a liquid that has a fragrance.

3. The apparatus of claim 2 wherein the liquid slowly evaporates as it is heated.

4. The apparatus of claim 1 wherein the cartridge has a reservoir for containing a gel.

5. The apparatus of claim 4 wherein the gel slowly evaporates when heated.

6. The apparatus of claim 3 wherein the liquid has a color that fades as the liquid evaporates during use.

7. The apparatus of claim 5 wherein the gel has a color that fades as the gel is exhausted during use.

8. The apparatus of claim 1 further comprising a switch that controls the intensity of the light bulb.

9. The apparatus of claim 1 wherein the housing is generally cylindrically shaped.

10. The apparatus of claim 1 wherein the housing has a bend portion.
